(19) United States
(12) Patent Application Publication
(10) Pub. No.: US 2026/0084053 A1
(43) Pub. Date: Mar. 26, 2026

(54) VIRTUAL ARTICLE DISPLAY FOR ONLINE GAMES

(71) Applicant: NETEASE (HANGZHOU) NETWORK CO., LTD., Hangzhou (CN)

(72) Inventor: Keqiang WU, Hangzhou (CN)

(21) Appl. No.: 18/992,536

(22) PCT Filed: Mar. 6, 2023
(86) PCT No.: PCT/CN2023/079908

§ 371 Date: Dec. 10, 2025

(30) Foreign Application Priority Data
Jul. 8, 2022 (CN) 202210806857.7

(51) Int. Cl. A63F 13/533; A63F 13/46

(52) U.S. Cl. CPC A63F 13/533; A63F 13/46; A63F 2300/8076

(57) ABSTRACT

According to this solution, a virtual item display scenario is designed in a game scenario, a player can set a virtual item for display in the virtual item display scenario. When entering the virtual item display scenario, a game character can view the virtual item displayed on an item display rack of the virtual item display scenario, thereby enhancing the sense of accomplishment of the player in collecting the virtual item. When item information of the virtual item is displayed, the item information is generated based on various data of the virtual item.

The present disclosure claims priority to Chinese Patent Application No. 202210806857.7 filed with the China National Intellectual Property Administration on 8 Jul. 2022 and titled “METHOD FOR DISPLAYING VIRTUAL ITEM, APPARATUS FOR DISPLAYING VIRTUAL ITEM, COMPUTER DEVICE, AND STORAGE MEDIUM”, the entire content of which is incorporated herein by reference.

### TECHNICAL FIELD

The present disclosure relates to the technical field of computers, and specifically relates to a method for displaying a virtual item, an apparatus for displaying a virtual item, a computer device, and a storage medium.

### BACKGROUND

With the development of Internet technologies and mobile terminal devices, online games have become an increasingly common form of entertainment.

In some shooting games, an interface will be usually provided specially to display a virtual weapon (such as weapon) model owned by a player. The player can observe the virtual weapon model by, e.g., rotation and zooming on this interface.

However, the existing method displays virtual weapons owned by the player only on a single interface, and displays a few contents for each of the virtual weapons with poor display effects, thereby affecting the player's experience in displaying the virtual weapons, extending running duration of a terminal device, and resulting in much power consumption of the terminal device.

### SUMMARY OF THE INVENTION

### Technical Issue

Embodiments of the present disclosure provide a method for displaying a virtual item, an apparatus for displaying a virtual item, a computer device, and a storage medium, thereby improving display effects of the virtual item in a game, shortening running duration of a terminal device, and reducing power consumption of the terminal device.

### Technical Solution

In a first aspect, an embodiment of the present disclosure provides a method for displaying a virtual item, including:
displaying a virtual item display shelf on a graphical user interface provided by a terminal device, wherein the virtual item display shelf is configured to display, in a virtual item display space of a player character, a virtual item of a specified type owned by the player character, the virtual item display shelf includes at least one item display column, and the item display column is configured to set the virtual item of the specified type to be displayed on the virtual item display shelf; and
determining, in response to a virtual item setting operation on the item display column, a target virtual item set in the item display column, to display a virtual item display shelf containing the target virtual item in the virtual item display space.

In a second aspect, an embodiment of the present disclosure further provides an apparatus for displaying a virtual item, including:
a display unit configured to display a virtual item display shelf on a graphical user interface provided by a terminal device, wherein the virtual item display shelf is configured to display, in a virtual item display space of a player character, a virtual item of a specified type owned by the player character, the virtual item display shelf includes at least one item display column, and the item display column is configured to set the virtual item of the specified type to be displayed on the virtual item display shelf; and
a first determination unit configured to determine, in response to a virtual item setting operation on the item display column, a target virtual item set in the item display column, to display a virtual item display shelf containing the target virtual item in the virtual item display space.

In a third aspect, an embodiment of the present disclosure further provides a computer device, including a memory, a processor, and a computer program stored on the memory and runnable on the processor, wherein the processor implements the method for displaying a virtual item provided in any one embodiment of the present disclosure.

In a fourth aspect, an embodiment of the present disclosure further provides a storage medium, wherein the storage medium stores a plurality of instructions, and the instructions are adapted to being loaded by a processor to implement the above method for displaying a virtual item.

### Beneficial Effects

According to embodiments of the present disclosure, by designing a virtual item display scenario in a game scenario, a game player can set a target virtual item to be displayed in the virtual item display scenario based on actual display requirements, so that a game character controlled by the game player, when entering the virtual item display scenario, can view virtual items displayed on an item display shelf in the virtual item display scenario, thereby enhancing the sense of accomplishment of the game player in collecting the virtual items. Moreover, when item information of the target virtual item is displayed, the item information is generated based on various data of the target virtual item, thereby facilitating viewing more detailed item information by the game player, improving display effects of the virtual items in a game, shortening running duration of a terminal device, and reducing power consumption of the terminal device.

### DESCRIPTION OF DRAWINGS

To more clearly describe technical solutions of embodiments of the present disclosure, drawings to be used in the description of the embodiments will be briefly introduced below. Apparently, the drawings described below are merely some embodiments of the present disclosure. For those skilled in the art, other drawings may also be obtained based on these drawings without creative work.

FIG. 1 is a schematic scenario diagram of a system for displaying a virtual item provided in one of embodiments of the present disclosure.

FIG. 2 is a schematic flowchart of a method for displaying a virtual item provided in one of embodiments of the present disclosure.

FIG. 3 is a schematic diagram of an application scenario of a method for displaying a virtual item provided in one of embodiments of the present disclosure.

FIG. 4 is a schematic diagram of an application scenario of another method for displaying a virtual item provided in one of embodiments of the present disclosure.

FIG. 5 is a schematic diagram of an application scenario of another method for displaying a virtual item provided in one of embodiments of the present disclosure.

FIG. 6 is a schematic diagram of an application scenario of another method for displaying a virtual item provided in one of embodiments of the present disclosure.

FIG. 7 is a schematic diagram of an application scenario of another method for displaying a virtual item provided in one of embodiments of the present disclosure.

FIG. 8 is a schematic diagram of an application scenario of another method for displaying a virtual item provided in one of embodiments of the present disclosure.

FIG. 9 is a schematic diagram of an application scenario of another method for displaying a virtual item provided in one of embodiments of the present disclosure.

FIG. 10 is a schematic diagram of an application scenario of another method for displaying a virtual item provided in one of embodiments of the present disclosure.

FIG. 11 is a schematic diagram of an application scenario of another method for displaying a virtual item provided in one of embodiments of the present disclosure.

FIG. 12 is a schematic diagram of an application scenario of another method for displaying a virtual item provided in one of embodiments of the present disclosure.

FIG. 13 is a schematic diagram of an application scenario of another method for displaying a virtual item provided in one of embodiments of the present disclosure.

FIG. 14 is a schematic flowchart of another method for displaying a virtual item provided in one of embodiments of the present disclosure.

FIG. 15 is a schematic diagram of an application scenario of another method for displaying a virtual item provided in one of embodiments of the present disclosure.

FIG. 16 is a structural block diagram of an apparatus for displaying a virtual item provided in one of embodiments of the present disclosure.

FIG. 17 is a schematic structural diagram of a computer device provided in one of embodiments of the present disclosure.

### EMBODIMENTS OF THE PRESENT DISCLOSURE

The technical solutions of the embodiments of the present disclosure will be clearly and completely described below in conjunction with the drawings in the embodiments of the present disclosure. Apparently, the embodiments described below are merely a part, instead of all, of the embodiments of the present disclosure. All other embodiments obtained by those skilled in the art based on the embodiments of the present disclosure without creative work are encompassed within the scope of protection of the present disclosure.

The embodiments of the present disclosure provide a method for displaying a virtual item, an apparatus for displaying a virtual item, a storage medium, and a computer device. Specifically, the method for displaying a virtual item in an embodiment of the present disclosure may be implemented by a computer device, wherein the computer device may be a device, such as a terminal or a server. The terminal may be a terminal device, such as a smart phone, a tablet computer, a notebook computer, a touch screen, a game machine, a personal computer (PC), or a personal digital assistant (PDA). The terminal may further include a client. The client may be, e.g., a game application client, a browser client carrying a game program, or an instant messaging client. The server may be a standalone physical server, or may be a server cluster or a distributed system composed of a plurality of physical servers, or may be a cloud server providing basic cloud computing service, such as cloud service, cloud database, cloud computing, cloud function, cloud storage, network service, cloud communication, middleware service, domain name service, security service, CDN, big data, and artificial intelligence platform.

For example, when the method for displaying a virtual item runs on the terminal, the terminal device stores a game application program, and is used to present a virtual scenario in a game screen. The terminal device is configured to interact with a user through a graphical user interface, such as downloading, installing, and running the game application program through the terminal device. The terminal device may provide the graphical user interface for the user in various modes, for example, the graphical user interface may be rendered and displayed on a display screen of the terminal device, or may be presented through holographic projection. For example, the terminal device may include a touch screen and a processor. The touch screen is configured to present the graphical user interface and receive an operating instruction generated by the user acting on the graphical user interface. The graphical user interface includes a game screen. The processor is configured to run the game, generate the graphical user interface, respond to the operating instruction, and control the display of the graphical user interface on the touch screen.

For example, when running on the server, the method for displaying a virtual item may be a cloud game. The cloud game refers to a gaming method based on cloud computing. In a running mode of the cloud game, a running body of the game application program is separated from a game screen presentation body, and the storage and running of the method for displaying a virtual item are completed on a cloud game server. The game screen presentation is completed on a cloud game client. The cloud game client is mainly configured to receive and transmit game data and present the game screen. For example, the cloud game client may be a display device that is close to a user side and has a data transmission function, such as a mobile terminal, a television set, a computer, a handheld computer, or a personal digital assistant, but the terminal device that performs game data processing is a cloud game server in cloud. When playing a game, the user operates the cloud game client to transmit the operating instruction to the cloud game server. The cloud game server runs the game based on the operating instruction, encodes and compresses the data such as the game screen, and returns the encoded and compressed data to the cloud game client through a network. Finally, the cloud game client decodes the encoded and compressed data, and outputs the game screen.

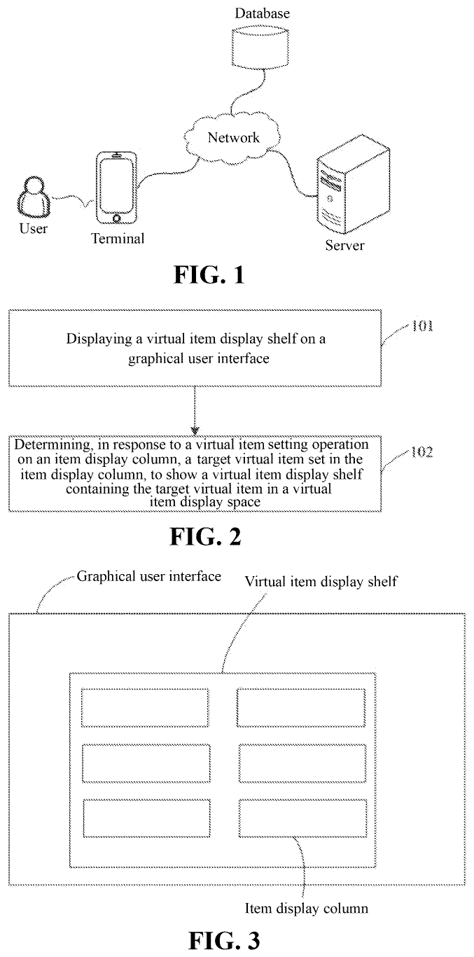

Referring to FIG. 1, FIG. 1 is a schematic scenario diagram of a system for displaying a virtual item provided in an embodiment of the present disclosure. The system may include at least one terminal, at least one server, at least one database, and a network. A terminal held by a user may be connected to servers of different games through the network. The terminal is any device with computing hardware capable of supporting and executing a software product corresponding to a game. In addition, the terminal includes one or more multi-touch sensitive screens configured to sense and obtain an input through a touch or sliding operation performed by a user at a plurality of points on one or more touch screens. In addition, when the system includes a plurality of terminals, a plurality of servers, and a plurality of networks, different terminals may be connected to each other through different networks and different servers. The network may be a wireless network or a wired network. For example, the wireless network may be a wireless local area network (WLAN), a local area network (LAN), a cellular network, a 2G network, a 3G network, a 4G network, a 5G network, etc. In addition, different terminals may also be connected to other terminals or connected to servers using their own Bluetooth networks or hotspot networks. For example, a plurality of users may be online via different terminals, so that they are connected through appropriate networks and synchronized with each other, to support multi-player games. In addition, the system may include a plurality of databases coupled to different servers, and information related to the game environment may be continuously stored in the databases when different users are playing multi-player games online.

An embodiment of the present disclosure provides a method for displaying a virtual item. The method may be implemented by a terminal or a server. The embodiment of the present disclosure is illustrated when the method for displaying a virtual item is implemented by, for example, a terminal. The terminal includes a touch screen and a processor. The touch screen is configured to present a graphical user interface and receive an operating instruction generated by the user acting on the graphical user interface. When the user operates the graphical user interface through the touch screen, the graphical user interface not only can control local content of the terminal in response to the received operating instruction, but also can control content of a peer server in response to the received operating instruction. For example, the operating instruction generated by the user acting on the graphical user interface includes an instruction for initiating a game application program, and the processor is configured to initiate the game application program after receiving the instruction for initiating the game application program provided by the user. In addition, the processor is configured to render and plot a graphical user interface associated with the game on the touch screen. The touch screen is a multi-touch sensitive screen that can sense touch or sliding operations simultaneously performed at a plurality of points on the screen. The user performs a touch operation on the graphical user interface using a finger. When detecting the touch operation, the graphical user interface controls different player characters in the graphical user interface of the game to perform actions corresponding to the touch operation. For example, the game may be any one of a casual game, an action game, a role-playing game, a strategy game, a sports game, a puzzle game, and the like. The game may include a virtual scenario of a game plotted on the graphical user interface. In addition, the virtual scenario of the game may include one or more player characters, such as a virtual character, controlled by the user (or player). In addition, the virtual scenario of the game may further include one or more obstacles, such as railings, ravines, and walls, to restrict movement of the player character, such as restricting movement of one or more objects to a particular region within the virtual scenario. Optionally, the virtual scenario of the game further includes one or more elements, such as skills, scores, character health status, or energy, to provide the player with help and virtual services, and increase scores related to the player performance, etc. In addition, the graphical user interface may further present one or more indicators to provide the player with indication information. For example, the game may include a player-controlled player character and one or more other player characters (such as enemy characters). In an embodiment, one or more other player characters are controlled by other players of the game. For example, one or more other player characters may be controlled by a computer, such as a robot using an artificial intelligence (AI) algorithm, to implement a man-machine battle mode. For example, the player character owns various skills or abilities used by a game player to achieve his goals. For example, the player character owns one or more weapons, props, tools, etc. that can be used to eliminate other objects from the game. Such skills or abilities may be activated by the game player using one of a plurality of preset touch operations on the touch screen of the terminal. The processor may be configured to present a corresponding game screen in response to the operating instruction generated by the touch operation of the user.

It should be noted that a schematic scenario diagram of a system for displaying a virtual weapon shown in FIG. 1 is only an example. An image processing system and an image processing scenario are described in the embodiments of the present disclosure to more clearly illustrate the technical solutions of the embodiments of the present disclosure, and do not impose any limitation on the technical solutions provided in the embodiments of the present disclosure. As appreciated by those of ordinary skills in the art, with the evolution of the system for displaying a virtual weapon and the emergence of new service scenarios, the technical solutions provided in the embodiments of the present disclosure are also adapted to similar technical problems.

Based on the above problems, the embodiments of the present disclosure provide a method for displaying a virtual item, an apparatus for displaying a virtual item, a computer device, and a storage medium, thereby improving display effects of the virtual item in a game, shortening running duration of a terminal device, and reducing power consumption of the terminal device. The detailed description will be provided below respectively. It should be noted that the order of description of the following embodiments does not impose any limitation on a preferred order of the embodiments.

An embodiment of the present disclosure provides a method for displaying a virtual item. The method may be implemented by a terminal or a server. The embodiment of the present disclosure is illustrated when the method for displaying a virtual item is implemented by, for example, a terminal.

Referring to FIG. 2, FIG. 2 is a schematic flowchart of a method for displaying a virtual item provided in an embodiment of the present disclosure. A specific process of the method for displaying a virtual item may be as follows:

101: displaying a virtual item display shelf on a graphical user interface.

The virtual item display shelf is configured to display, in a virtual item display space of a player character, a virtual item of a specified type owned by a player character, the virtual item display shelf includes at least one item display column, and the item display column is configured to set the virtual item of the specified type to be displayed on the virtual item display shelf.

In an embodiment of the present disclosure, the virtual item display space is provided in a game scenario, and the virtual item display space can be used to display the virtual item of the specified type owned by the player character.

The virtual item owned by the player character in a game includes virtual items of a plurality of types, the specified type may be one of the plurality of types, for example, the specified type may be a weapon type, and the virtual item display space can be used to display a virtual weapon owned by the player character.

Specifically, a game player controlling the player character can select some or all virtual items of the specified type from all of the virtual items owned by the player character, and set the selected virtual items in the virtual item display shelf, that is, can display the selected virtual items in the virtual item display space.

For example, referring to FIG. 3, FIG. 3 is a schematic diagram of an application scenario of a method for displaying a virtual item provided in an embodiment of the present disclosure. In the graphical user interface shown in FIG. 3, the virtual item display shelf is displayed, the virtual item display shelf includes a plurality of item display columns, and the item display columns can be used for the player to set a to-be-displayed virtual item of the specified type owned by the player character.

102: determining, in response to a virtual item setting operation on the item display column, a target virtual item set in the item display column, to display a virtual item display shelf containing the target virtual item in the virtual item display space.

In some embodiments, in order to facilitate a selection operation of the game player on the virtual item, the step “determining, in response to a virtual item setting operation on the item display column, a target virtual item set in the item display column” may include the following operations:
displaying, in response to a first operation on the graphical user interface, the virtual item owned by the player character on the graphical user interface; and
determining, in response to an item transfer operation between the item display column and the virtual item owned by the player character, the target virtual item set in the item display column.

The first operation may be used to trigger the display of the virtual item owned by the player character in the game on the graphical user interface. The first operation may include a plurality of operations, such as a clicking operation, a pressing operation, and a sliding operation.

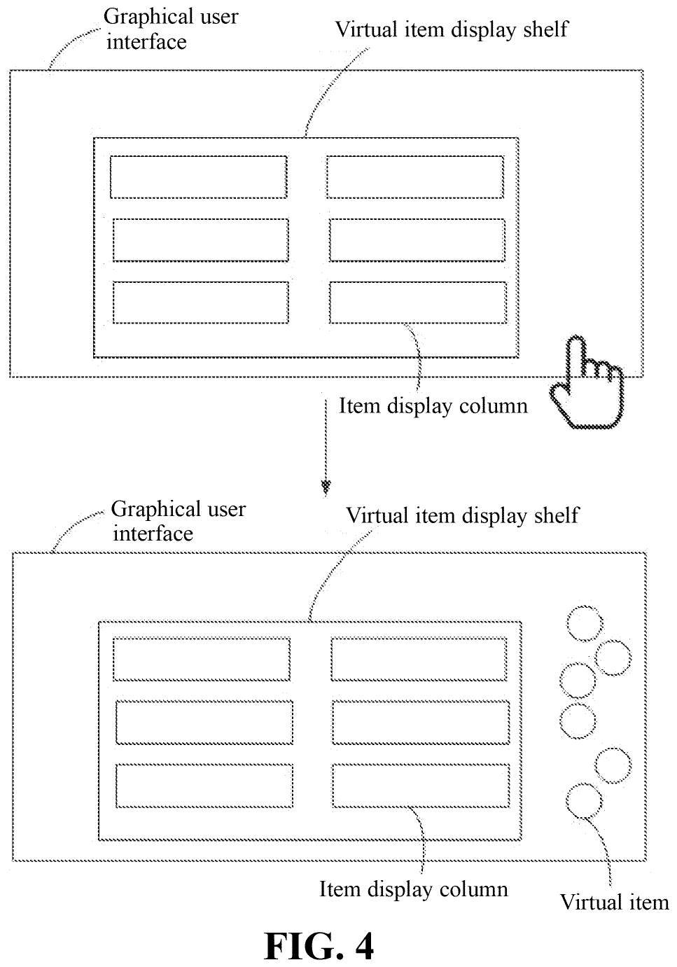

For example, referring to FIG. 4, FIG. 4 is a schematic diagram of an application scenario of another method for displaying a virtual item provided in an embodiment of the present disclosure. In the graphical user interface shown in FIG. 4, the virtual item display shelf is displayed on the graphical user interface. When the first operation of the game player on the graphical user interface is detected, the graphical user interface displays the virtual item owned by the player character, so that the game player can select a virtual item, and set it in the item display column.

In some embodiments, in order to facilitate the game player to set the virtual item in the virtual item display column, the graphical user interface may be provided with an item display widget, and the step “displaying, in response to the first operation on the graphical user interface, the virtual item owned by the player character on the graphical user interface” may include the following operation:
displaying, in response to the touch operation on the item display widget, the virtual item owned by the player character on the graphical user interface.

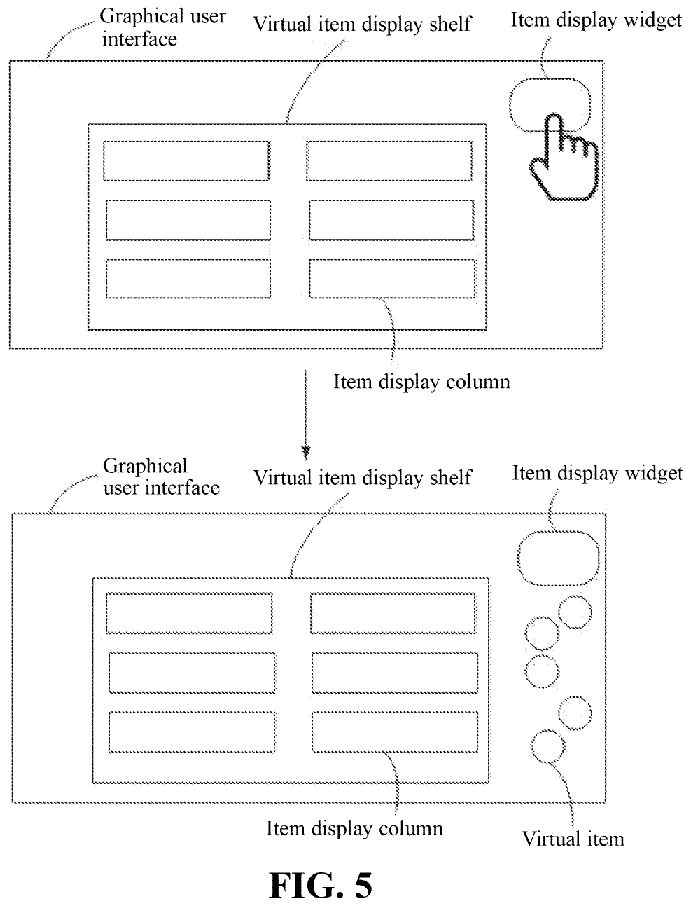

For example, referring to FIG. 5, FIG. 5 is a schematic diagram of an application scenario of another method for displaying a virtual item provided in an embodiment of the present disclosure. In the graphical user interface shown in FIG. 5, the graphical user interface displays the virtual item display shelf, and is provided with the item display widget. When the touch operation of the game player on the provided item display widget is detected, the virtual item owned by the player character is displayed on the graphical user interface, so that the game player can select a virtual item, and set it in the item display column.

In some embodiments, the step “determining, in response to the item transfer operation between the item display column and the virtual item owned by the player character, the target virtual item set in the item display column”may include the following operations:
determining, in response to a selection operation on the virtual item owned by the player character, a to-be-put-on-shelf virtual item; and
determining, in response to moving the to-be-put-on-shelf virtual item to the item display column, the target virtual item based on the to-be-put-on-shelf virtual item.

Specifically, when the graphical user interface displays a virtual item display shelf and the virtual item owned by the player character, the game player can directly move the virtual item to the virtual item display column of the virtual item display shelf, to complete item setting in the virtual item display column.

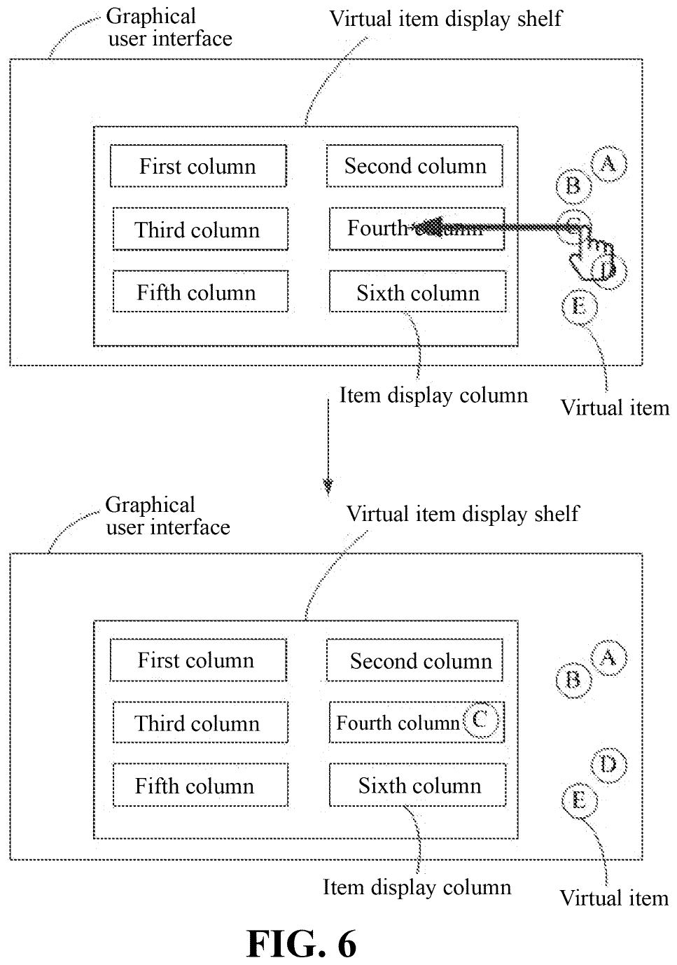

For example, referring to FIG. 6, FIG. 6 is a schematic diagram of an application scenario of another method for displaying a virtual item provided in an embodiment of the present disclosure. In the graphical user interface shown in FIG. 6, a virtual item display shelf is displayed, and virtual item display columns of the virtual item display shelf include: a first column, a second column, a third column, a fourth column, a fifth column, and a sixth column. The graphical user interface further displays virtual items owned by the player character, which may include: item A, item B, item C, item D, and item E. When a selection operation of a game player on the item C is detected, a to-be-put-on-shelf virtual item may be determined as: the item C, then the game player is detected to move the item C to the fourth column, and then the target virtual item may be determined as: the item C. The item C is displayed in the fourth column of the virtual item display shelf.

In an embodiment of the present disclosure, a virtual item setting interface is further designed. The virtual item setting interface can be used by the game player to set a virtual prop to be displayed in the virtual item display space. The virtual item setting interface may include a first region and a second region. The first region is used to set a virtual item to be displayed in the virtual item display space of the player character in the game scenario, and the second region displays a virtual prop owned by the current virtual character.

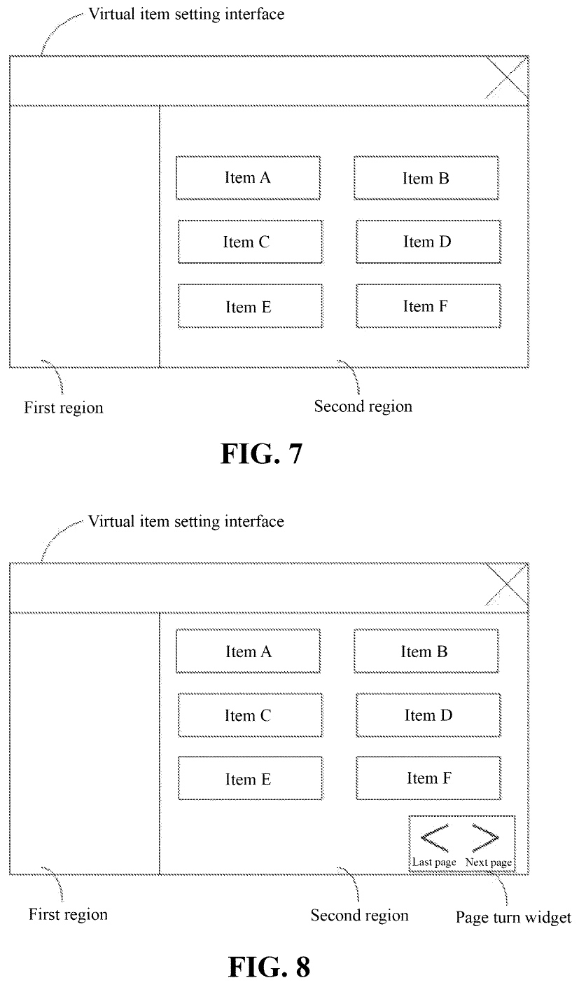

For example, referring to FIG. 7, FIG. 7 is a schematic diagram of an application scenario of another method for displaying a virtual item provided in an embodiment of the present disclosure. The virtual item setting interface shown in FIG. 7 includes a first region and a second region, wherein the second region displays virtual items owned by a current virtual character, which may include, e.g., item A, item B, item C, item D, item E, and item F.

In some embodiments, due to limited display size of the second region, when the player character owns a large number of virtual items, a page turn widget may be set in the second region, the virtual items may be distributed on a plurality of pages, and the page turn widget may be used to trigger display of a last page or a next page.

For example, referring to FIG. 8, FIG. 8 is a schematic diagram of an application scenario of another method for displaying a virtual item provided in an embodiment of the present disclosure. In the virtual item setting interface shown in FIG. 8, a page turn widget is provided in the second region, and a touch operation on the page turn widget triggers selection of a virtual item on the last page or the next page for display.

In some embodiments, in order to facilitate the game player to quickly select a to-be-set virtual item, a search bar may be provided in the second region, and the game player may search by entering the name of the virtual item in the search bar, thereby quickly selecting the to-be-set virtual item.

In some embodiments, the setting a virtual item to be displayed in the virtual item display space based on the virtual item setting interface may include the following operation:
determining, in response to a virtual item transfer operation between the first region and the second region, a target virtual item set in the first region.

The virtual item transfer operation is used to transfer a virtual item in the first region to the second region for display, or to transfer a virtual item in the second region to the first region for display. The target virtual item refers to a virtual item set to be displayed in the virtual item display space.

In some embodiments, in order to facilitate the operation of the game player, the step “determining, in response to the virtual item transfer operation between the first region and the second region, the target virtual item set in the first region” may include the following operations:
determining, in response to a touch operation for the second region, a to-be-put-on-shelf virtual item from virtual items in the second region;
moving, in response to a touch operation for the to-be-put-on-shelf virtual item, the to-be-put-on-shelf virtual item to the first region; and
determining the target virtual item based on the to-be-put-on-shelf virtual item.

The touch operation for the second region may be, e.g., a clicking, pressing, or sliding operation. When the touch operation on the second region is detected, a virtual item corresponding to the touch operation is acquired to obtain the to-be-put-on-shelf virtual item.

The touch operation for the to-be-put-on-shelf virtual item may be, e.g., a clicking, pressing, or sliding operation. When the touch operation on the to-be-put-on-shelf virtual item is detected, the to-be-put-on-shelf virtual item may be moved from the second region to the first region, and then the to-be-put-on-shelf virtual item may be determined as the target virtual item.

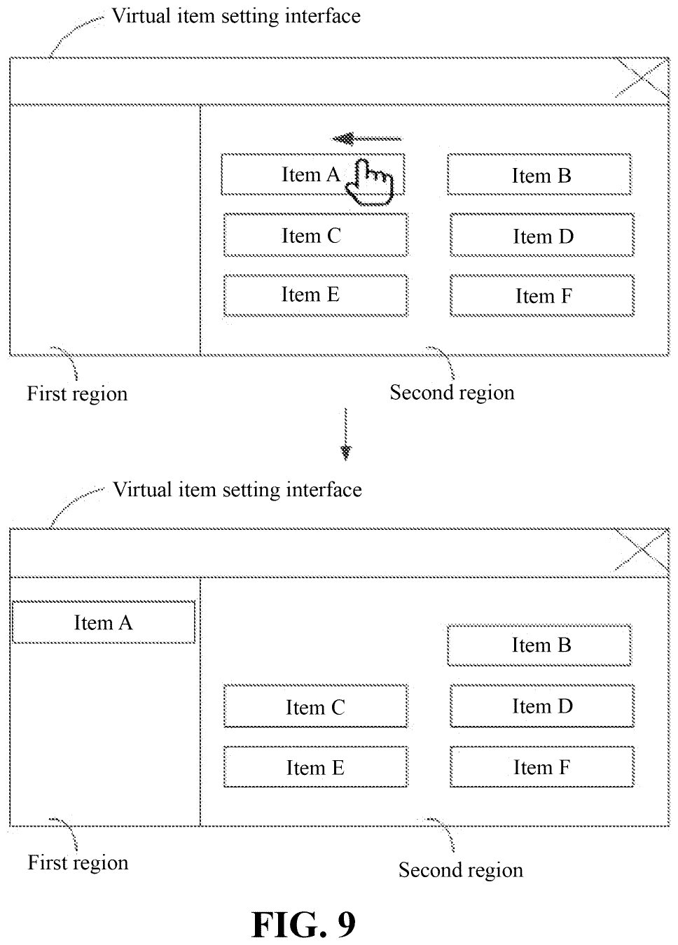

For example, referring to FIG. 9, FIG. 9 is a schematic diagram of an application scenario of another method for displaying a virtual item provided in an embodiment of the present disclosure. In the virtual item setting interface shown on an upper side of FIG. 9, when a clicking operation on the second region is detected, the virtual item corresponding to the clicking operation may be obtained as: the item A. Further, when a sliding operation on the item A from the second region to the first region is detected, the item A is moved from the second region to the first region for display, and then the item A is determined as the target virtual item set to be displayed in the virtual item display space.

In some embodiments, in order to facilitate the operation of the game player, the step “determining, in response to the virtual item transfer operation between the first region and the second region, the target virtual item set in the first region” may include the following operations:
determining, in response to a touch operation for the first region, a to-be-taken-off-shelf virtual item from virtual items in the first region;
moving, in response to a touch operation for the to-be-taken-off-shelf virtual item, the to-be-taken-off-shelf virtual item to the second region; and
determining the target virtual item based on virtual items other than the to-be-taken-off-shelf virtual item in the first region.

The touch operation for the first region may be, e.g., a clicking, pressing, or sliding operation. When the touch operation on the first region is detected, a virtual item corresponding to the touch operation is acquired to obtain the to-be-taken-off-shelf virtual item.

The touch operation for the to-be-put-on-shelf virtual item may be, e.g., a clicking, pressing, or sliding operation. When the touch operation on the to-be-taken-off-shelf virtual item is detected, the to-be-taken-off-shelf virtual item may be moved from the first region to the second region, and the to-be-taken-off-shelf virtual item may be removed from the target virtual item, that is, the display of the to-be-taken-off-shelf virtual item in the virtual item display space is canceled.

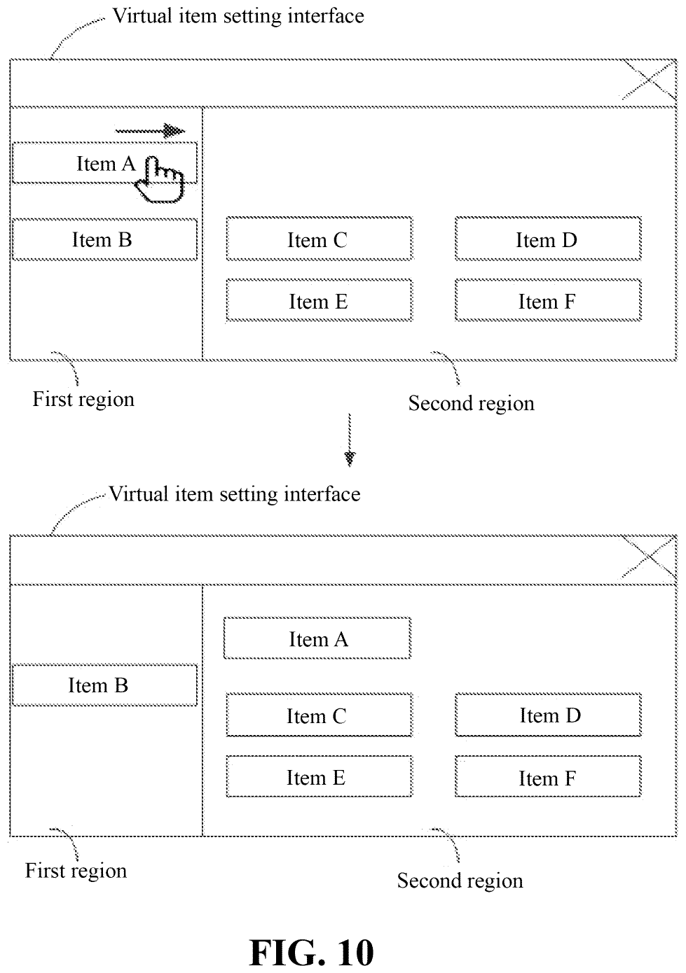

For example, referring to FIG. 10, FIG. 10 is a schematic diagram of an application scenario of another method for displaying a virtual item provided in an embodiment of the present disclosure. In the virtual item setting interface shown on an upper side of FIG. 10, the first region includes: item A and item B, that is, the target virtual items that have been set to be displayed in the virtual item display space are the item A and the item B. The second region includes virtual items that are not set to be displayed in the virtual item display space: item C, item D, item E, and item F.

When a clicking operation on the first region is detected, a virtual item corresponding to the clicking operation may be: the item A. Further, when a sliding operation on the item A from the first region to the second region is detected, the item A is moved from the first region to the second region for display, and then the item A is determined to be eliminated to be displayed in the virtual item display space, and the target virtual item to be displayed in the virtual item display space is obtained as the item B.

In some embodiments, the number of virtual item columns that may be configured to set the virtual item to be displayed on the virtual item display shelf is determined based on level information of the player character, that is, the number of virtual items displayable in the virtual item display space of the player character is determined based on game information of the player character in the game.

For example, the level information may be a level of the virtual item display space of the player character. The higher the level of the virtual item display space is, the larger the number of virtual items displayable in the virtual item display space of the player character is.

In an embodiment of the present disclosure, the level of the virtual item display space is designed to be improved in a plurality of ways. For example, the level of the virtual item display space can be improved by consuming a virtual resource (such as game currency) in the game. Accordingly, since the virtual items displayable in the virtual item display space are set in the first region, the number of virtual items settable in the first region is smaller than or equal to the number of virtual items displayable in the virtual item display space.

For example, a game level of the player character may be: level 10. When the game level is level 10, the number of virtual items displayable in the virtual item display space may be: 5, and then the number of virtual items settable in the first region may be smaller than or equal to 5.

In some embodiments, the graphical user interface can display a game screen. The game screen at least includes a part of the game scenario and the player character. The player character may be a virtual game character controlled by the game player. The method may further include the following step:
displaying, in response to the player character entering the virtual item display space in the game scenario, the virtual item display shelf containing the target virtual item in the virtual item display space.

In an embodiment of the present disclosure, at least one virtual item display space is set in the game scenario. When the player character is detected to enter the virtual item display space, the virtual item display shelf set with the target virtual item can be displayed in the virtual item display space.

In some embodiments, the graphical user interface may be provided with a movement widget, which is configured to control the player character to move in the game scenario. The game player can control the player character to move in the game scenario by operating the movement widget.

For example, the game player can operate the movement widget to control the player character to enter the virtual item display space in the game scenario. In this case, the game scenario displayed on the graphical user interface may be the virtual item display space displaying the target virtual item. The game player can see the target virtual item set to be displayed in the virtual space, thereby giving the game player a sense of satisfaction in owning virtual items.

In some embodiments, the virtual item display shelf contains a plurality of target virtual items. In order to quickly determine a target virtual item to be displayed to the game player for viewing, the step “displaying the virtual item display shelf containing the target virtual item in the virtual item display space” may include the following operations:
determining, based on a relative position between the player character and each of item display columns in the virtual item display shelf, a target item display column from the item display columns in the virtual item display shelf; and
correspondingly displaying, in the target item display column of the virtual item display shelf, the target virtual item set in the target item display column.

The relative position may include a distance. First, a distance between the player character and each item display column in the game scenario is acquired, then an item display column closest to the player character is selected from the plurality of item display columns to obtain the target item display column, and then the target virtual item set in the target item display column is displayed in the virtual item display space.

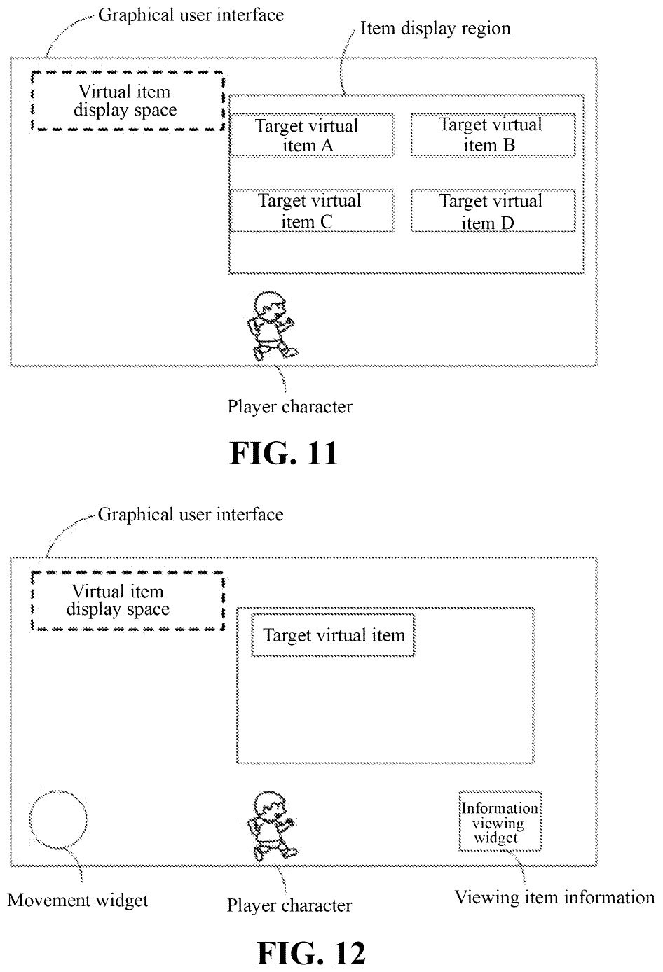

For example, referring to FIG. 11, FIG. 11 is a schematic diagram of an application scenario of another method for displaying a virtual item provided in an embodiment of the present disclosure. In the graphical user interface shown in FIG. 11, the virtual item display space and the player character located in the virtual item display space are displayed. The virtual item display space may include an item display region, and the item display region may be used to display target virtual items, including: target virtual item A, target virtual item B, target virtual item C, and target virtual item D.

Further, a distance between the player character and a display position of each target virtual item in the virtual item display space is acquired, a target virtual item closest to the player character is selected, for example, may be: the target virtual item C, and then the target virtual item C may be specifically displayed in the item display region item display information of the target virtual item closest to the player character can be smartly displayed without an operation by the game player, thereby facilitating viewing the virtual item information by the game player.

In some embodiments, the method may further include the following step:
displaying, in response to the player character and a teammate player character of the player character entering the virtual item display space in the game scenario, the virtual item display shelf containing the target virtual item in the virtual item display space.

The teammate player character is a player character accepting an invitation initiated by the player character to view the virtual item display shelf.

In an embodiment of the present disclosure, in a process of teaming up for the game, the player character can invite a member of his team, that is, the teammate player character, to enter the virtual item display space, so that the teammate player character can view the target virtual item displayed in the virtual item display space, thereby satisfying a sense of satisfaction of the current game player in displaying the target virtual item to others.

In some embodiments, the step “displaying the virtual item display shelf containing the target virtual item in the virtual item display space” may include the following operation:
displaying item display information of the target virtual item on the virtual item display shelf in the virtual item display space.

Specifically, in order to facilitate viewing detailed information of the target virtual item by the game player, the item display information of the target virtual item can be displayed on the virtual item display shelf in the virtual item display space. The item display information at least includes, e.g., an item model and item introduction of the target virtual item.

In some embodiments, the graphical user interface is provided with an information viewing widget, which is configured to trigger the display of the item display information of the target virtual item on the graphical user interface.

For example, referring to FIG. 12, FIG. 12 is a schematic diagram of an application scenario of another method for displaying a virtual item provided in an embodiment of the present disclosure. In the graphical user interface shown in FIG. 12, the virtual item display space and the player character located in the virtual item display widget are displayed. The graphical user interface is further provided with a movement widget for controlling the player character to move in the game scenario and an information viewing widget for viewing the item display information of the target virtual item. The text content “view item information” is displayed on the information viewing widget, and can be used to remind the game player of the function of this widget. When a touch operation of the game player on the information viewing widget is detected, the item display information of the target virtual item can be displayed on the graphical user interface.

In some embodiments, in order to facilitate knowing about more complete information of the target virtual item by the game player, the step “displaying the item display information of the target virtual item on the virtual item display shelf in the virtual item display space”may further include the following steps:
acquiring an item display model and item information of the target virtual item;
generating an item tag of the target virtual item based on the item information; and
obtaining the item display information based on the item display model and the item tag.

The item display model refers to a model diagram of the target virtual item, and the item display model may be a spatial model, such as a three-dimensional model. The item information includes all information of the target virtual item in the game. The item tag of the target virtual item can be determined based on the item information of the target virtual item, and then the item display information of the target virtual item can be obtained based on the item tag and the item display model. That is, the item display information at least includes: the item display model and the item tag.

In some embodiments, in order to determine the accuracy of the generated item tag, the step “generating the item tag of the target virtual item based on the item information” may include the following operations:
acquiring an item attribute parameter of the target virtual item from the item information;
determining an attribute score of the target virtual item based on the item attribute parameter; and
determining an attribute identifier and an attribute description text based on the attribute score to obtain the item tag.

The item information includes an item attribute parameter file. By reading the item attribute parameter file, various item attribute parameters of the target virtual item are obtained. Then, the attribute score of the target virtual item is calculated based on the item attribute parameter.

Specifically, the attribute value score of the target virtual item may be calculated based on the item attribute parameter by calculating a product of the item attribute parameter and a weight, to obtain the attribute value score, as per the calculation method as follows:

attribute value score=each item attribute parameter×weight;
wherein the attribute identifier is determined based on the attribute score, and the attribute identifier is also a displayed attribute emblem. In an embodiment of the present disclosure, a preset attribute score level may include a plurality of attribute levels, different attribute levels correspond to different attribute value score ranges, different attribute levels correspond to different attribute emblems, an attribute level of the target virtual item may be determined based on the attribute value score of the target virtual item, and then the attribute identifier of the target virtual item may be determined based on the attribute emblem corresponding to the attribute level.

The attribute description text is determined based on the attribute score, that is, the attribute description text includes: the attribute score. Further, the item tag is obtained based on the attribute identifier and the attribute description text.

In some embodiments, in order to determine the accuracy of the generated item tag, the step “generating the item tag of the target virtual item based on the item information” may include the following operations:
acquiring a total number of historic owners of the target virtual item and a strength score of a previous owner from the item information;
determining a loot value score of the target virtual item based on the total number of historic owners and the strength score of the previous owner; and
determining a loot value identifier and a loot value description text based on the loot value score, to obtain the item tag.

The historic owners refer to game players owning the target virtual item prior to a current moment.

For example, prior to the current moment, game players owning the target virtual item may include, e.g., player A, player B, and player C. The player A, the player B, and the player C are the historic owners of the target virtual item, and the total number of historic owners is: 3.

The previous owner is a previous game player owning the target virtual item, and the strength score of the previous owner may be obtained based on performance of the previous game player in the game. Then, the loot value score of the target virtual item is calculated based on the total number of historic owners and the strength score of the previous owner.

Specifically, the loot value score of the target virtual item may be calculated based on the total number of historic owners and the strength score of the previous owner by calculating a product of the total number of historic owners and a preset first weight, calculating a product of the strength score of the previous owner and a preset second weight, and adding the two products, to obtain the loot value score, as per the calculation method as follows:

loot value score=total number of historic owners×weight 1+strength score of previous owner×weight 2;
wherein the loot value identifier is determined based on the loot value score, and the loot value identifier is also a displayed loot value emblem. In an embodiment of the present disclosure, a preset loot value score level may include a plurality of loot value levels, different loot value levels correspond to different loot value score ranges, different loot value levels correspond to different loot value emblems, a loot value level of the target virtual item may be determined based on the loot value score of the target virtual item, and then the loot value identifier of the target virtual item may be determined based on the loot value emblem corresponding to the loot value level.

The loot value description text is determined based on the loot value score, that is, the loot value description text includes: the loot value score. Further, the item tag is obtained based on the loot value identifier and the loot value description text.

In some embodiments, in order to determine the accuracy of the generated item tag, the step “generating the item tag of the target virtual item based on the item information” may include the following operations:
acquiring the number of battlefields and the number of insurance retrievals of the target virtual item from the item information;
determining a companion value score of the target virtual item based on the number of battlefields and the number of insurance retrievals; and
determining a companion value identifier and a companion value description text based on the companion value score, to obtain the item tag.

In an embodiment of the present disclosure, insurance refers to such a game playstyle that the game player can insure a virtual item by consuming a virtual resource outside a game round. If an equipment discarded/dropped by the game player in a game round has been insured, and is not picked up by other game players before the round is over, the equipment can be returned to the game player in the form of an email after the game round is over.

The number of battlefields refers to the number of game rounds in which the current game player uses the target virtual item, and the number of insurance retrievals refers to the number of retrievals of the insured target virtual item by the current game player. Then, the companion value score of the target virtual item is calculated based on the number of battlefields and the number of insurance retrievals.

Specifically, the companion value score of the target virtual item may be calculated based on the number of battlefields and the number of insurance retrievals by calculating a product of the number of battlefields and a preset third weight, calculating a product of the number of insurance retrievals and a preset fourth weight, and adding the two products, to obtain the companion value score, as per the calculation method as follows:

companion value score=number of battlefields×weight 3+number of insurance retrievals×weight 4;
wherein a companion value score identifier is determined based on the companion value score, and the companion value identifier is also a displayed companion value emblem. In an embodiment of the present disclosure, the preset companion value score level may include a plurality of companion value levels, different companion value levels correspond to different companion value score ranges, different companion value levels correspond to different companion value emblems, a companion value level of the target virtual item can be determined based on the companion value score of the target virtual item, and then the companion value identifier of the target virtual item is determined based on the companion value emblem corresponding to the companion value level.

The companion value description text is determined based on the companion value score, that is, the companion value description text includes: the companion value score. Further, the item tag is obtained based on the companion value identifier and the companion value description text.

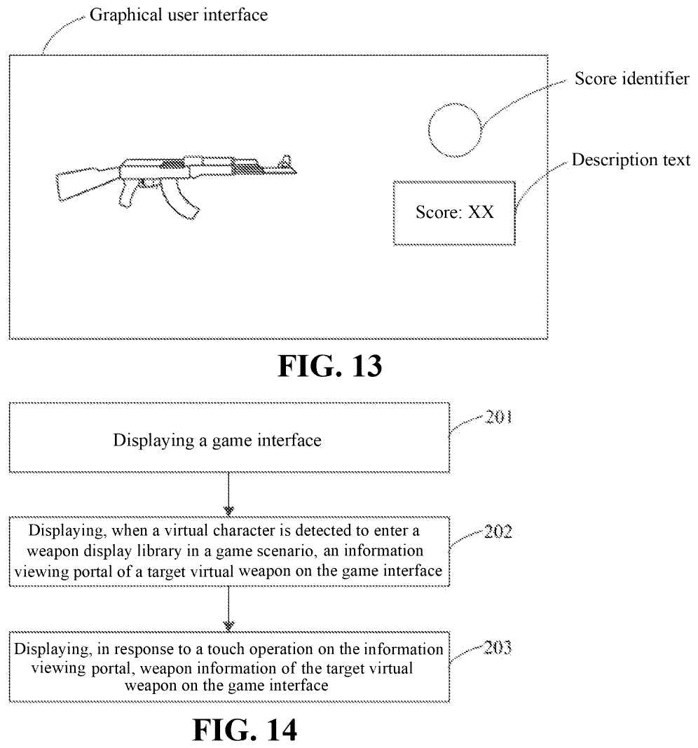

For example, referring to FIG. 13, FIG. 13 is a schematic diagram of an application scenario of another method for displaying a virtual item provided in an embodiment of the present disclosure. In the graphical user interface shown in FIG. 13, item display information of the target virtual item is displayed, including: an item display model, a score identifier, and a description text of the target virtual item. The score identifier is obtained based on an item tag, the item tag may include a plurality of item tags, the score identifier may also include a plurality of score identifiers, and accordingly, the description text may also include a plurality of description texts.

An embodiment of the present disclosure discloses a method for displaying a virtual item. The method includes: displaying a virtual item display shelf on a graphical user interface, wherein the virtual item display shelf is configured to display, in a virtual item display space of a player character, a virtual item of a specified type owned by the player character, the virtual item display shelf includes at least one item display column, and the item display column is configured to set the virtual item of the specified type to be displayed on the virtual item display shelf; and determining, in response to a virtual item setting operation on the item display column, a target virtual item set in the item display column, to display the virtual item display shelf containing the target virtual item in the virtual item display space, thereby improving display effects of a virtual weapon in a game, shortening running duration of a terminal device, and reducing power consumption of the terminal device.

Based on the above introduction, an example will be given below to further illustrate the method for displaying a virtual item of the present disclosure. Referring to FIG. 14, FIG. 14 is a schematic flowchart of another method for displaying a virtual item provided in an embodiment of the present disclosure. The specific process may be as follows:

201: displaying a game interface.

In an embodiment of the present disclosure, the game interface includes a part of a game scenario, a virtual game character located in the game scenario, and an interface interaction widget. The interface interaction widget is used for an interactive operation between a game player and the game interface. For example, the interface interaction widget may include a movement widget, and the game player can control a virtual game character to move in the game scenario through a touch operation on the movement widget.

202: displaying, when a virtual character is detected to enter a weapon display library in the game scenario, an information viewing portal of a target virtual weapon on the game interface.

The weapon display library refers to a virtual weapon library scenario used to display a virtual weapon in the game scenario. In an embodiment of the present disclosure, the weapon display library is designed in the game scenario, to facilitate viewing a virtual weapon collected or owned by the game player in the virtual weapon library scenario.

The weapon display library includes a plurality of weapon display shelves, each of which includes a virtual weapon. The weapon display library may include a plurality of virtual weapons, and the target virtual weapon is one virtual weapon among the plurality of virtual weapons.

Specifically, the target virtual weapon may be determined from the plurality of virtual weapons by determining a target weapon display shelf closest to the position of the virtual game character from the weapon display shelves based on position information of the virtual game character and position information of the weapon display shelves in the weapon display library, and further determining the target virtual weapon based on virtual weapons included in the target weapon display shelf.

After the target virtual weapon is determined, the information viewing portal of the target virtual weapon can be displayed on the game interface, and the information viewing portal is used to view weapon information of the target virtual weapon.

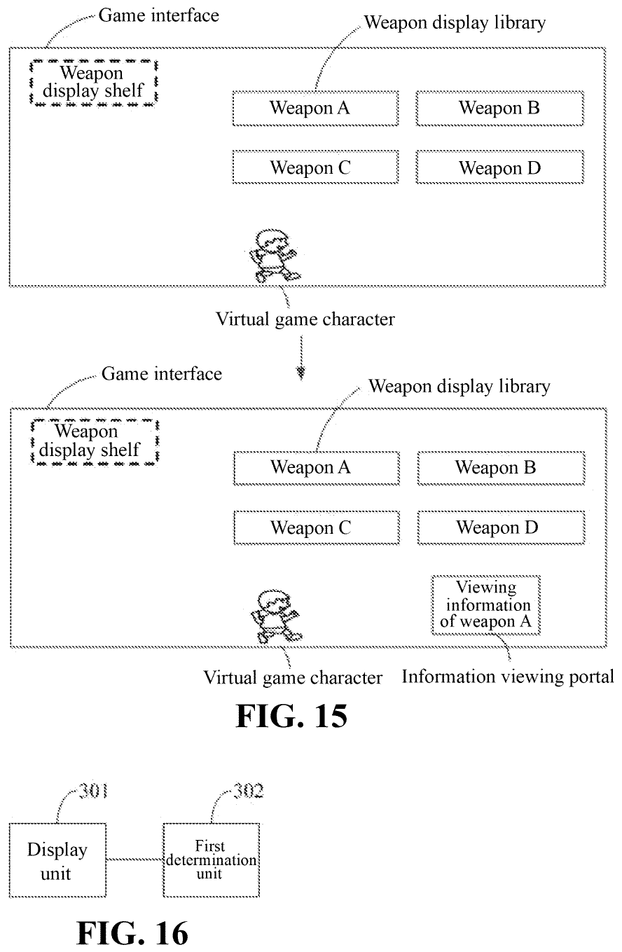

For example, referring to FIG. 15, FIG. 15 is a schematic diagram of an application scenario of another method for displaying a virtual item provided in an embodiment of the present disclosure. In the game interface shown in FIG. 15, when the virtual game character is detected to enter the weapon display library, virtual weapons set by the game player to be displayed are displayed on the weapon display shelves, including: weapon A, weapon B, weapon C, and weapon D, and then, the weapon display shelf closest to the position of the virtual game character is selected from the plurality of weapon display shelves, to obtain the target weapon display shelf, which may be: a weapon display shelf of the weapon A. An information viewing portal of the weapon A is displayed on the game interface, and the game player can trigger the game interface to display information of the weapon A through an operation on the information viewing portal.

203: displaying, in response to a touch operation on the information viewing portal, the weapon information of the target virtual weapon on the game interface.

Further referring to FIG. 15, when the touch operation of the game player on the information viewing portal is detected, the display of the weapon information of the target virtual weapon on the game interface can be triggered.

In an embodiment of the present disclosure, the weapon information includes a weapon tag, and the weapon tag at least may be classified into three categories: a weapon attribute, a weapon loot, and a weapon companion value. Display content of the weapon tag at least includes text description and a rating emblem.

Specifically, the weapon attribute may be obtained by reading a planning sheet on a client. The planning sheet stores an attribute parameter of a firearm, and is equivalent to a parameter file. The planning sheet is equivalent to a modifiable parameter file.

weapon attribute value score=each weapon attribute value×weight.

The text description includes the weapon attribute value score. The rating may be classified into 3 levels. The threshold of each score level is controlled based on the planning sheet, and each level corresponds to a different rating emblem.

Specifically, a total number of previous weapon owners, strength of a previous owner, and nickname of the previous owner are recorded on a server, and are updated every time the weapon owner changes.

weapon loot value score total number of historic weapon owners×weight 1+strength score of previous weapon owner×weight 2.

The text description includes the total number of historic weapon owners, the nickname of the previous weapon owner, and the weapon loot value score. The rating is classified into 3 levels. The threshold of each score level is controlled based on the planning sheet, and each level corresponds to a different rating emblem.

Specifically, the number of battlefields in which the player uses the weapon and the number of insurance retrievals of the weapon by the player are stored on the server, and are updated every time a corresponding behavior occurs.
weapon companion value score=number of battlefields in which the player uses the weapon×weight 3+number of insurance retrievals of the weapon by the player×weight 4. The rating is classified into 3 levels. The threshold of each score level is controlled based on the planning sheet, and each level corresponds to a different rating emblem.

Specifically, the weapon information of the target virtual weapon displayed on the game interface includes: a weapon model of the target virtual weapon, a weapon attribute emblem, weapon attribute description, a weapon loot value emblem, weapon loot description, a weapon companion value emblem, and weapon companion value description. On this basis, the game player can view detailed information of the weapons, and know more about each virtual weapon.

In some embodiments, the current game player may further invite other game players to enter his own weapon display library. After other game players enter the weapon display library of the current game player, other game players can see a weapon rack of the current player and a firearm model hanging on the weapon rack. Other game players can select a virtual weapon on the weapon rack, and view a tag display interface.

For example, the current player invites other game players to team up for a game. When other game players join in the team, they can automatically enter the weapon library of the team leader player. Other game players not only can observe details of the weapon library of the team leader player, but also can click to view the tag display interface of the firearm hung by the team leader player on the weapon rack.

An embodiment of the present disclosure discloses a method for displaying a virtual item. The method includes: displaying a game interface; displaying, when a virtual character is detected to enter a weapon display library in a game scenario, an information viewing portal of a target virtual weapon on the game interface; and displaying, in response to a touch operation on the information viewing portal, weapon information of the target virtual weapon on the game interface, thereby improving display effects of a virtual weapon in a game, shortening running duration of a terminal device, and reducing power consumption of the terminal device.

In order to facilitate better implementation of the method for displaying a virtual item provided in embodiments of the present disclosure, an embodiment of the present disclosure further provides an apparatus for displaying a virtual item based on the above method for displaying a virtual item. Meanings of the terms are same as those in the above method for displaying a virtual item. The description in the method embodiments may be referred to for specific implementation details.

Referring to FIG. 16, FIG. 16 is a structural block diagram of an apparatus for displaying a virtual item provided in an embodiment of the present disclosure. The apparatus includes:
a display unit 301 configured to display a virtual item display shelf on a graphical user interface, wherein the virtual item display shelf is configured to display, in a virtual item display space of a player character, a virtual item of a specified type owned by the player character, the virtual item display shelf includes at least one item display column, and the item display column is configured to set the virtual item of the specified type to be displayed on the virtual item display shelf; and
a first determination unit 302 configured to determine, in response to a virtual item setting operation on the item display column, a target virtual item set in the item display column, to display a virtual item display shelf containing the target virtual item in the virtual item display space.

In some embodiments, the apparatus may further include:
a first display unit configured to display, in response to the player character entering the virtual item display space in the game scenario, the virtual item display shelf containing the target virtual item in the virtual item display space.

In some embodiments, the first display unit may include:
a first determination subunit configured to determine, based on a relative position between the player character and each of item display columns in the virtual item display shelf, a target item display column from the item display columns in the virtual item display shelf; and
a first display subunit configured to correspondingly display, in the target item display column of the virtual item display shelf, the target virtual item set in the target item display column.

In some embodiments, the apparatus may further include:
a second display subunit configured to display, in response to the player character and a teammate player character of the player character entering the virtual item display space in the game scenario, the virtual item display shelf containing the target virtual item in the virtual item display space, wherein the teammate player character is a player character accepting an invitation initiated by the player character to view the virtual item display shelf.

In some embodiments, the display unit 301 may include:
a first display subunit configured to display item display information of the target virtual item on the virtual item display shelf in the virtual item display space.

In some embodiments, the apparatus may further include:
an acquisition unit configured to acquire an item display model and item information of the target virtual item;
a generation unit configured to generate an item tag of the target virtual item based on the item information; and
a second determination unit configured to obtain the item display information based on the item display model and the item tag.

In some embodiments, the generation unit may include:
a first acquisition subunit configured to acquire an item attribute parameter of the target virtual item from the item information;
a second determination subunit configured to determine an attribute score of the target virtual item based on the item attribute parameter; and
a third determination subunit configured to determine an attribute identifier and an attribute description text based on the attribute score to obtain the item tag.

In some embodiments, the generation unit may include:
a second acquisition subunit configured to acquire a total number of historic owners of the target virtual item and a strength score of a previous owner from the item information;
a fourth determination subunit configured to determine a loot value score of the target virtual item based on the total number of historic owners and the strength score of the previous owner; and
a fifth determination subunit configured to determine a loot value identifier and a loot value description text based on the loot value score, to obtain the item tag.

In some embodiments, the generation unit may include:
a third acquisition subunit configured to acquire the number of battlefields and the number of insurance retrievals of the target virtual item from the item information;
a sixth determination subunit configured to determine a companion value score of the target virtual item based on the number of battlefields and the number of insurance retrievals; and
a seventh determination subunit configured to determine a companion value identifier and a companion value description text based on the companion value score, to obtain the item tag.

In some embodiments, the first determination unit 302 may include:
a second display subunit configured to display, in response to a first operation on the graphical user interface, the virtual item owned by the player character on the graphical user interface; and
an eighth determination subunit configured to determine, in response to an item transfer operation between the item display column and the virtual item owned by the player character, the target virtual item set in the item display column.

In some embodiments, the eighth determination subunit may be specifically configured to:
determine, in response to a selection operation on the virtual item owned by the player character, a to-be-put-on-shelf virtual item; and
determine, in response to moving the to-be-put-on-shelf virtual item to the item display column, the target virtual item based on the to-be-put-on-shelf virtual item.

An embodiment of the present disclosure discloses an apparatus for displaying a virtual item. The apparatus displays, by a display unit 301, a virtual item display shelf on a graphical user interface, wherein the virtual item display shelf is configured to display, in a virtual item display space of a player character, a virtual item of a specified type owned by the player character, the virtual item display shelf includes at least one item display column, and the item display column is configured to set the virtual item of the specified type to be displayed on the virtual item display shelf, and determines, by a first determination unit 302 and in response to a virtual item setting operation on the item display column, a target virtual item set in the item display column, to display the virtual item display shelf containing the target virtual item in the virtual item display space, thereby improving display effects of a virtual weapon in a game, shortening running duration of a terminal device, and reducing power consumption of the terminal device.

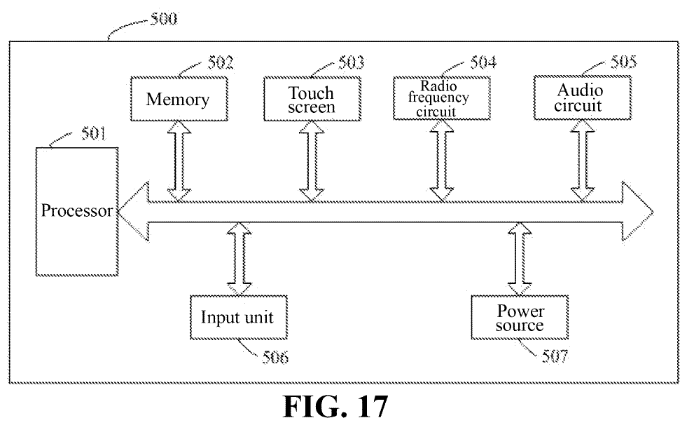

Accordingly, an embodiment of the present disclosure further provides a computer device, which may be a terminal. As shown in FIG. 17, FIG. 17 is a schematic structural diagram of a computer device provided in an embodiment of the present disclosure. The computer device 500 includes a processor 501 having one or more than one processing core, a memory 502 having one or more than one computer-readable storage medium, and a computer program stored on the memory 502 and runnable on the processor. The processor 501 is electrically connected to the memory 502. Those skilled in the art can understand that the structure of the computer device shown in the figure does not constitute any limitation to the computer device, and may include more or fewer components than those shown in the figure, or may combine some components, or may have different component arrangements.

The processor 501 is a control center of the computer device 500, connects various parts of the entire computer device 500 using various interfaces and wires, implements various functions of the computer device 500 by running or loading software programs and/or modules stored in the memory 502, and implements data processing by invoking data stored in the memory 502, thereby performing overall monitoring on the computer device 500.

In an embodiment of the present disclosure, the processor 501 in the computer device 500 will load instructions corresponding to processes of one or more than one application program into the memory 502 following the steps below, and the processor 501 runs the application program stored in the memory 502, thereby implementing various functions:
displaying a virtual item display shelf on a graphical user interface, wherein the virtual item display shelf is configured to display, in a virtual item display space of a player character, a virtual item of a specified type owned by the player character, the virtual item display shelf includes at least one item display column, and the item display column is configured to set the virtual item of the specified type to be displayed on the virtual item display shelf; and
determining, in response to a virtual item setting operation on the item display column, a target virtual item set in the item display column, to display a virtual item display shelf containing the target virtual item in the virtual item display space.

In some embodiments, at least a part of a game scenario is displayed on the graphical user interface, and the method further includes:
displaying, in response to the player character entering the virtual item display space in the game scenario, the virtual item display shelf containing the target virtual item in the virtual item display space.

In some embodiments, the virtual item display shelf contains a plurality of target virtual items; and
the displaying the virtual item display shelf containing the target virtual item in the virtual item display space includes:
determining, based on a relative position between the player character and each of item display columns in the virtual item display shelf, a target item display column from the item display columns in the virtual item display shelf, and
correspondingly displaying, in the target item display column of the virtual item display shelf, the target virtual item set in the target item display column.

In some embodiments, the method further includes:
displaying, in response to the player character and a teammate player character of the player character entering the virtual item display space in the game scenario, the virtual item display shelf containing the target virtual item in the virtual item display space, wherein the teammate player character is a player character accepting an invitation initiated by the player character to view the virtual item display shelf.

In some embodiments, the displaying the virtual item display shelf containing the target virtual item in the virtual item display space includes:
displaying item display information of the target virtual item on the virtual item display shelf in the virtual item display space.

In some embodiments, before the displaying the item display information of the target virtual item on the virtual item display shelf in the virtual item display space, the method further includes:
acquiring an item display model and item information of the target virtual item;
generating an item tag of the target virtual item based on the item information; and
obtaining the item display information based on the item display model and the item tag.

In some embodiments, the generating the item tag of the target virtual item based on the item information includes:
acquiring an item attribute parameter of the target virtual item from the item information;
determining an attribute score of the target virtual item based on the item attribute parameter; and
determining an attribute identifier and an attribute description text based on the attribute score to obtain the item tag.

In some embodiments, the generating the item tag of the target virtual item based on the item information includes:
acquiring a total number of historic owners of the target virtual item and a strength score of a previous owner from the item information;
determining a loot value score of the target virtual item based on the total number of historic owners and the strength score of the previous owner; and
determining a loot value identifier and a loot value description text based on the loot value score, to obtain the item tag.

In some embodiments, the generating the item tag of the target virtual item based on the item information includes:
acquiring the number of battlefields and the number of insurance retrievals of the target virtual item from the item information;
determining a companion value score of the target virtual item based on the number of battlefields and the number of insurance retrievals; and
determining a companion value identifier and a companion value description text based on the companion value score, to obtain the item tag.

In some embodiments, the determining, in response to a virtual item setting operation on the item display column, a target virtual item set in the item display column includes:
displaying, in response to a first operation on the graphical user interface, the virtual item owned by the player character on the graphical user interface; and
determining, in response to an item transfer operation between the item display column and the virtual item owned by the player character, the target virtual item set in the item display column.

In some embodiments, the determining, in response to the item transfer operation between the item display column and the virtual item owned by the player character, the target virtual item set in the item display column includes:
determining, in response to a selection operation on the virtual item owned by the player character, a to-be-put-on-shelf virtual item; and
determining, in response to moving the to-be-put-on-shelf virtual item to the item display column, the target virtual item based on the to-be-put-on-shelf virtual item.

In some embodiments, the number of virtual item columns that may be configured to set the virtual item to be displayed on the virtual item display shelf is determined based on level information of the player character.

According to embodiments of the present disclosure, by designing a virtual item display scenario in a game scenario, a game player can set a target virtual item to be displayed in the virtual item display scenario based on actual display requirements, so that a game character controlled by the game player, when entering the virtual item display scenario, can view virtual items displayed on an item display shelf in the virtual item display scenario, thereby enhancing the sense of accomplishment of the game player in collecting the virtual items. Moreover, when item information of the target virtual item is displayed, the item information is generated based on various data of the target virtual item, thereby facilitating viewing more detailed item information by the game player, improving display effects of the virtual items in a game, shortening running duration of a terminal device, and reducing power consumption of the terminal device.

The above embodiments may be referred to for specific implementations of the above operations, which will not be repeated here.

Optionally, as shown in FIG. 17, the computer device 500 further includes: a touch screen 503, a radio frequency circuit 504, an audio circuit 505, an input unit 506, and a power source 507. The processor 501 is electrically connected to the touch screen 503, the radio frequency circuit 504, the audio circuit 505, the input unit 506, and the power source 507 respectively. Those skilled in the art can understand that the structure of the computer device shown in FIG. 17 does not constitute any limitation to the computer device, and may include more or fewer components than those shown in the figure, or may combine some components, or may have different component arrangements.

The touch screen 503 may be configured to display a graphical user interface and receive an operating instruction generated by a user acting on the graphical user interface. The touch screen 503 may include a display panel and a touch panel. The display panel may be configured to display information inputted by the user or information provided to the user, and various graphical user interfaces of the computer device. These graphical user interfaces may be composed of graphics, texts, icons, videos, and any combination thereof. Optionally, the display panel may be configured in the form of, e.g., a liquid crystal display (LCD) or an organic light-emitting diode (OLED). The touch panel may be configured to collect a touch operation of the user thereon or in the vicinity thereof (such as an operation of the user on or in the vicinity of the touch panel using a finger, a touch pen, or any appropriate object or accessory), and generate a corresponding operating instruction, which executes a corresponding program. Optionally, the touch panel may include two parts: a touch detection apparatus and a touch controller. The touch detection apparatus detects a touch orientation of the user, detects a signal brought by the touch operation, and transmits the signal to the touch controller. The touch controller receives touch information from the touch detection apparatus, converts it into contact point coordinates, then transmits the contact point coordinates to the processor 501, can receive a command transmitted from the processor 501, and can execute the command. The touch panel can cover the display panel. After detecting the touch operation on or in the vicinity of the touch panel, the touch panel transmits the touch operation to the processor 501 to determine a type of a touch event, and then the processor 501 provides a corresponding visual output on the display panel based on the type of the touch event. In an embodiment of the present disclosure, the touch panel and the display panel may be integrated into the touch screen 503 to implement input and output functions. However, in some embodiments, the touch panel and the touch panel may be used as two standalone components to implement input and output functions. That is, the touch screen 503 may also be used as a part of the input unit 506 to implement the input function.

The radio frequency circuit 504 may be configured to transmit/receive a radio frequency signal, so as to establish wireless communication with a network device or other computer devices through wireless communication, and transmit/receive signals to/from the network device or other computer devices.

The audio circuit 505 may be configured to provide an audio interface between the user and the computer device through a speaker or a microphone. The audio circuit 505 can transmit an electrical signal converted from received audio data to the speaker, which converts the electrical signal into an acoustical signal and outputs the acoustical signal. On the other hand, the microphone converts the collected acoustical signal into an electrical signal, which is received by the audio circuit 505, and then converted into audio data. Then, the audio data is outputted to the processor 501 for processing, and then transmitted to, for example, another computer device through the radio frequency circuit 504, or the audio data is outputted to the memory 502 for further processing. The audio circuitry 505 may further include an earphone jack, to provide communication between a peripheral earphone and the computer device.

The input unit 506 may be configured to receive an inputted number, character information, or user feature information (such as a fingerprint, an iris, or facial information), and generate keyboard, mouse, joystick, optical or trackball signal input related to user settings and function control.

The power source 507 is configured to power various components of the computer device 500. Optionally, the power source 507 may be logically connected to the processor 501 through a power management system, thereby managing functions such as charging, discharging, and power consumption management through the power management system. The power source 507 may further include one or more than one DC or AC power source, a recharging system, a power failure detection circuit, a power converter or inverter, a power status indicator, and any other components.

Although not shown in FIG. 17, the computer device 500 may further include, e.g., a camera, a sensor, a wireless fidelity module, and a Bluetooth module, which will not be repeated here.

In the above embodiments, particular emphasis is laid on description of each embodiment. Relevant descriptions of other embodiments may be referred to for parts that are not described in detail in an embodiment.

As can be seen from the above, the computer device provided in the present embodiment can display a virtual item display shelf on a graphical user interface, wherein the virtual item display shelf is configured to display, in a virtual item display space of a player character, a virtual item of a specified type owned by the player character, the virtual item display shelf includes at least one item display column, and the item display column is configured to set the virtual item of the specified type to be displayed on the virtual item display shelf; and determining, in response to a virtual item setting operation on the item display column, a target virtual item set in the item display column, to display the virtual item display shelf containing the target virtual item in the virtual item display space.

Those of ordinary skills in the art can understand that all or a part of the steps in the methods of the above embodiments can be completed through instructions, or be completed by controlling related hardware through instructions, wherein the instructions may be stored in a computer-readable storage medium, and loaded and executed by a processor.

To this end, an embodiment of the present disclosure provides a computer-readable storage medium in which a plurality of computer programs are stored. The computer programs can be loaded by a processor to implement steps in any one method for displaying a virtual item provided in embodiments of the present disclosure. For example, the computer programs can implement the following steps:
displaying a virtual item display shelf on a graphical user interface, wherein the virtual item display shelf is configured to display, in a virtual item display space of a player character, a virtual item of a specified type owned by the player character, the virtual item display shelf includes at least one item display column, and the item display column is configured to set the virtual item of the specified type to be displayed on the virtual item display shelf, and
determining, in response to a virtual item setting operation on the item display column, a target virtual item set in the item display column, to display a virtual item display shelf containing the target virtual item in the virtual item display space.

In some embodiments, at least a part of a game scenario is displayed on the graphical user interface, and the method further includes:
displaying, in response to the player character entering the virtual item display space in the game scenario, the virtual item display shelf containing the target virtual item in the virtual item display space.

In some embodiments, the virtual item display shelf contains a plurality of target virtual items; and
the displaying the virtual item display shelf containing the target virtual item in the virtual item display space includes:
determining, based on a relative position between the player character and each of item display columns in the virtual item display shelf, a target item display column from the item display columns in the virtual item display shelf; and
correspondingly displaying, in the target item display column of the virtual item display shelf, the target virtual item set in the target item display column.

In some embodiments, the method further includes:
displaying, in response to the player character and a teammate player character of the player character entering the virtual item display space in the game scenario, the virtual item display shelf containing the target virtual item in the virtual item display space, wherein the teammate player character is a player character accepting an invitation initiated by the player character to view the virtual item display shelf.

In some embodiments, the displaying the virtual item display shelf containing the target virtual item in the virtual item display space includes:
displaying item display information of the target virtual item on the virtual item display shelf in the virtual item display space.

In some embodiments, before the displaying the item display information of the target virtual item on the virtual item display shelf in the virtual item display space, the method further includes:
acquiring an item display model and item information of the target virtual item;
generating an item tag of the target virtual item based on the item information; and
obtaining the item display information based on the item display model and the item tag.

In some embodiments, the generating the item tag of the target virtual item based on the item information includes:
acquiring an item attribute parameter of the target virtual item from the item information;
determining an attribute score of the target virtual item based on the item attribute parameter; and
determining an attribute identifier and an attribute description text based on the attribute score to obtain the item tag.

In some embodiments, the generating the item tag of the target virtual item based on the item information includes:
acquiring a total number of historic owners of the target virtual item and a strength score of a previous owner from the item information;
determining a loot value score of the target virtual item based on the total number of historic owners and the strength score of the previous owner; and
determining a loot value identifier and a loot value description text based on the loot value score, to obtain the item tag.

In some embodiments, the generating the item tag of the target virtual item based on the item information includes:
acquiring the number of battlefields and the number of insurance retrievals of the target virtual item from the item information;
determining a companion value score of the target virtual item based on the number of battlefields and the number of insurance retrievals; and
determining a companion value identifier and a companion value description text based on the companion value score, to obtain the item tag.

In some embodiments, the determining, in response to a virtual item setting operation on the item display column, a target virtual item set in the item display column includes:
displaying, in response to a first operation on the graphical user interface, the virtual item owned by the player character on the graphical user interface; and
determining, in response to an item transfer operation between the item display column and the virtual item owned by the player character, the target virtual item set in the item display column.

In some embodiments, the determining, in response to the item transfer operation between the item display column and the virtual item owned by the player character, the target virtual item set in the item display column includes:
determining, in response to a selection operation on the virtual item owned by the player character, a to-be-put-on-shelf virtual item; and
determining, in response to moving the to-be-put-on-shelf virtual item to the item display column, the target virtual item based on the to-be-put-on-shelf virtual item.

In some embodiments, the number of virtual item columns that may be configured to set the virtual item to be displayed on the virtual item display shelf is determined based on level information of the player character.

According to embodiments of the present disclosure, by designing a virtual item display scenario in a game scenario, a game player can set a target virtual item to be displayed in the virtual item display scenario based on actual display requirements, so that a game character controlled by the game player, when entering the virtual item display scenario, can view virtual items displayed on an item display shelf in the virtual item display scenario, thereby enhancing the sense of accomplishment of the game player in collecting the virtual items. Moreover, when item information of the target virtual item is displayed, the item information is generated based on various data of the target virtual item, thereby facilitating viewing more detailed item information by the game player, improving display effects of the virtual items in a game, shortening running duration of a terminal device, and reducing power consumption of the terminal device.

The above embodiments may be referred to for specific implementations of the above operations, which will not be repeated here.

The storage medium may include, e.g., a read only memory (ROM), a random access memory (RAM), and a magnetic disk or an optical disk.

Since the computer programs stored in the storage medium can implement the steps in any one method for displaying a virtual item provided in the embodiments of the present disclosure, the beneficial effects that can be achieved by any one method for displaying a virtual item provided in the embodiments of the present disclosure can be achieved, details of which are shown in the above embodiments and will not be repeated here.

The method for displaying a virtual item, the apparatus for displaying a virtual item, the storage medium, and the computer device provided in the embodiments of the present disclosure are introduced in detail above. Specific examples are used herein to illustrate the principles and implementations of the present disclosure. The description of the above embodiments is only provided to help in understanding the method of the present disclosure and core concept thereof. Moreover, those skilled in the art will make alterations to the specific embodiments and application scope based on the concept of the present disclosure. To sum up, the content of the present specification should not be construed as limiting the present disclosure.

1. A method for displaying a virtual item, comprising:
displaying a virtual item display shelf on a graphical user interface provided by a terminal device, wherein the virtual item display shelf is configured to display, in a virtual item display space of a first player character, a virtual item of a specified type owned by the first player character, the virtual item display shelf comprises an item display column, and the item display column is configured to set the virtual item of the specified type to be displayed on the virtual item display shelf; and
determining, in response to a virtual item setting operation on the item display column, a target virtual item set in the item display column, to display the virtual item display shelf comprising the target virtual item in the virtual item display space.

2. The method according to claim 1, wherein the graphical user interface displays at least a part of a game scenario, the method further comprising:
displaying, in response to the first player character entering the virtual item display space in the game scenario, the virtual item display shelf comprising the target virtual item in the virtual item display space.

3. The method according to claim 2, wherein the virtual item display shelf comprises a plurality of target virtual items, and displaying the virtual item display shelf comprising the target virtual item in the virtual item display space comprises:
determining, based on a relative position of the first player character and each of item display columns in the virtual item display shelf, a target item display column from the item display columns in the virtual item display shelf; and
displaying, in the target item display column of the virtual item display shelf, the target virtual item set in the target item display column.

4. The method according to claim 2, wherein the method further comprises:
displaying, in response to the first player character and a teammate player character entering the virtual item display space in the game scenario, the virtual item display shelf comprising the target virtual item in the virtual item display space, wherein the teammate player character is a player character accepting an invitation initiated by the first player character to view the virtual item display shelf.

5. The method according to claim 1, wherein displaying the virtual item display shelf comprising the target virtual item in the virtual item display space comprises:
displaying item display information of the target virtual item on the virtual item display shelf in the virtual item display space.

6. The method according to claim 5, wherein before displaying the item display information of the target virtual item on the virtual item display shelf in the virtual item display space, the method further comprises:
acquiring an item display model of the target virtual item and item information of the target virtual item;
generating an item tag of the target virtual item based on the item information; and
obtaining the item display information based on the item display model and the item tag.

7. The method according to claim 6, wherein generating the item tag of the target virtual item based on the item information comprises:
acquiring an item attribute parameter of the target virtual item from the item information;
determining an attribute score of the target virtual item based on the item attribute parameter; and
determining an attribute identifier and an attribute description text based on the attribute score to obtain the item tag.

8. The method according to claim 6, wherein generating the item tag of the target virtual item based on the item information comprises:
acquiring a total number of previous owners of the target virtual item and a strength score of a most recent previous owner from the item information;
determining a loot value score of the target virtual item based on the total number of previous owners and the strength score of the most recent previous owner; and
determining a loot value identifier and a loot value description text based on the loot value score, to obtain the item tag.

9. The method according to claim 6, wherein generating the item tag of the target virtual item based on the item information comprises:
acquiring a number of battlefields and a number of insurance retrievals of the target virtual item from the item information;
determining a companion value score of the target virtual item based on the number of battlefields and the number of insurance retrievals; and
determining a companion value identifier and a companion value description text based on the companion value score, to obtain the item tag.

10. The method according to claim 1, wherein determining, in response to the virtual item setting operation on the item display column, the target virtual item set in the item display column comprises:
displaying, in response to a first operation on the graphical user interface, the virtual item owned by the first player character on the graphical user interface; and
determining, in response to an item transfer operation between the item display column and the virtual item owned by the first player character, the target virtual item set in the item display column.

11. The method according to claim 10, wherein determining, in response to the item transfer operation between the item display column and the virtual item owned by the first player character, the target virtual item set in the item display column comprises:
determining, in response to a selection operation on the virtual item owned by the first player character, a to-be-put-on-shelf virtual item; and
determining, in response to moving the to-be-put-on-shelf virtual item to the item display column, the target virtual item based on the to-be-put-on-shelf virtual item.

12. The method according to claim 1, wherein a number of virtual item columns configured to set the virtual item to be displayed on the virtual item display shelf is determined based on level information of the first player character.

13. (canceled)

14. A system, comprising:
one or more memories collectively containing one or more programs; and
one or more processors, wherein the one or more processors are configured to, individually or collectively, perform an operation comprising:
displaying a virtual item display shelf on a graphical user interface provided by a terminal device, wherein the virtual item display shelf is configured to display, in a virtual item display space of a first player character, a virtual item of a specified type owned by the first player character, the virtual item display shelf comprises an item display column, and the item display column is configured to set the virtual item of the specified type to be displayed on the virtual item display shelf; and
determining, in response to a virtual item setting operation on the item display column, a target virtual item set in the item display column, to display the virtual item display shelf comprising the target virtual item in the virtual item display space.

15. One or more non-transitory computer-readable storage media containing, in any combination, computer program code that, when executable by a computer system, perform an operation comprising:
displaying a virtual item display shelf on a graphical user interface provided by a terminal device, wherein the virtual item display shelf is configured to display, in a virtual item display space of a first player character, a virtual item of a specified type owned by the first player character, the virtual item display shelf comprises an item display column, and the item display column is configured to set the virtual item of the specified type to be displayed on the virtual item display shelf; and
determining, in response to a virtual item setting operation on the item display column, a target virtual item set in the item display column, to display the virtual item display shelf comprising the target virtual item in the virtual item display space.

16. The one or more non-transitory computer-readable storage media of claim 15, wherein the graphical user interface displays at least a part of a game scenario, the operation further comprising:
displaying, in response to the first player character entering the virtual item display space in the game scenario, the virtual item display shelf comprising the target virtual item in the virtual item display space.

17. The one or more non-transitory computer-readable storage media of claim 16, wherein the virtual item display shelf comprises a plurality of target virtual items, and
displaying the virtual item display shelf comprising the target virtual item in the virtual item display space comprises:
determining, based on a relative position of the first player character and each of item display columns in the virtual item display shelf, a target item display column from the item display columns in the virtual item display shelf; and
displaying, in the target item display column of the virtual item display shelf, the target virtual item set in the target item display column.

18. The one or more non-transitory computer-readable storage media of claim 16, wherein the operation further comprises:
displaying, in response to the first player character and a teammate player character entering the virtual item display space in the game scenario, the virtual item display shelf comprising the target virtual item in the virtual item display space, wherein the teammate player character is a player character accepting an invitation initiated by the first player character to view the virtual item display shelf.

19. The one or more non-transitory computer-readable storage media of claim 15, wherein displaying the virtual item display shelf comprising the target virtual item in the virtual item display space comprises:
displaying item display information of the target virtual item on the virtual item display shelf in the virtual item display space.

20. The one or more non-transitory computer-readable storage media of claim 19, wherein before displaying the item display information of the target virtual item on the virtual item display shelf in the virtual item display space, the operation further comprises:
acquiring an item display model of the target virtual item and item information of the target virtual item;
generating an item tag of the target virtual item based on the item information; and
obtaining the item display information based on the item display model and the item tag.

21. The one or more non-transitory computer-readable storage media of claim 20, wherein generating the item tag of the target virtual item based on the item information comprises:
acquiring an item attribute parameter of the target virtual item from the item information;
determining an attribute score of the target virtual item based on the item attribute parameter; and
determining an attribute identifier and an attribute description text based on the attribute score to obtain the item tag.
